(19) United States
(12) Patent Application Publication
(10) Pub. No.: US 2020/0319580 A1
(43) Pub. Date: Oct. 8, 2020

(54) IMAGE FORMING APPARATUS

(71) Applicant: Konica Minolta, Inc., Tokyo (JP)

(72) Inventor: Masahiro MATSUO, Tokyo (JP)

(21) Appl. No.: 16/798,927

(22) Filed: Feb. 24, 2020

(30) Foreign Application Priority Data
Apr. 3, 2019 (JP) 2019-071472

(51) Int. Cl. G03G 15/20; G03G 15/00

(52) U.S. Cl. CPC G03G 15/2028; G03G 15/5062; G03G 15/652; G03G 15/2064

(57) ABSTRACT

An image forming apparatus according to the present invention includes: a conveyor that conveys continuous paper; an image former that forms an image on the continuous paper being conveyed; a fixer that pressurizes and heats the continuous paper passing through a fixing nip by bringing rotor into pressure contact with each other to form the fixing nip and rotating the rotors, to fix an image on the continuous paper; and a hardware processor that releases the fixing nip and stop rotation of the rotors and conveyance of the continuous paper by the conveyor when a lastly formed image in accordance with a print job passes through the fixing nip, the hardware processor then performing re-conveyance in which the continuous paper is conveyed by the conveyor with the fixing nip being left released and without rotation of the rotors, before performing warm-up of the fixer.

### CROSS-REFERENCE TO RELATED APPLICATION

Japanese Patent Application No. 2019-071472 filed on Apr. 3, 2019, including description, claims, drawings, and abstract the entire disclosure is incorporated herein by reference in its entirety.

### BACKGROUND

### 1. Technological Field

The present invention relates to an image forming apparatus.

### 2. Description of the Related Art

Conventionally, there has been known an image forming apparatus adopting electrography, in which an electrostatic latent image formed by irradiation on a uniformly-electrified photoconductor with laser light is developed through supply of toner to form a toner image, and the toner image is transferred and fixed onto a paper sheet to form an image on the paper sheet. The toner image is heated and pressurized when the paper sheet passes through a fixing nip formed of rotors being in pressure contact with each other in a fixer, to be fixed onto the paper sheet.

With regard to formation of the image on continuous paper with the image forming apparatus, there is known a technique of changing a stopping position of the continuous paper conveyed from the image forming apparatus, depending on a user's purpose or the like.

In connection with this technique, Unexamined Japanese Patent Publication No. 2019-8217 discloses the following conventional art. Switching between first control in which rotors being in pressure contact in the fixer are separated after conveyance of continuous paper is stopped, and second control in which conveyance of continuous paper is stopped after the rotors being in pressure contact are separated, is performed in accordance with a stopping position as accepted. This allows the continuous paper to be stopped in a desired stopping position. In accordance with the desired stopping position, generated waste paper can be reduced and a high winding quality can be achieved.

### SUMMARY

However, according to the above-described conventional art, when conveyance of the continuous paper is stopped, slack may possibly occur in the continuous paper due to the inertia of the rotors of the fixer or due to release of the rotors from pressure contact. Thus, depending on a method for warm-up that is to be performed later and requires rotation of the rotors of the fixer, the continuous paper may possibly be wound around the rotors due to a warming-up operation.

The present invention has been devised in order to solve those problems. That is, an object of the present invention is to provide an image forming apparatus that can prevent continuous paper from being wound around rotors due to a warming-up operation of the fixer.

To achieve at least the above-mentioned object, according to an aspect of the present invention, the image forming apparatus reflecting one aspect of the present invention comprises a conveyor that conveys continuous paper; an image former that forms an image on said continuous paper being conveyed; a fixer that pressurizes and heats said continuous paper passing through a fixing nip with said fixing nip by bringing rotors into pressure contact with each other to form said fixing nip and rotating said rotors, to fix an image on said continuous paper onto said continuous paper; and a hardware processor that releases said fixing nip and stops rotation of said rotors and conveyance of said continuous paper by said conveyor when a lastly formed image in accordance with a print job passes through said fixing nip, said hardware processor then performing re-conveyance in which said continuous paper is conveyed by said conveyor with said fixing nip being left released and without rotation of said rotors, before performing warm-up of said fixer.

The objects, features, and characteristics of this invention other than those set forth above will become apparent from the description given herein below with reference to preferred embodiments illustrated in the accompanying drawings.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a view of an overall configuration schematically illustrating an image forming system;

FIG. 2 is a block diagram illustrating a configuration of an image forming apparatus;

FIGS. 3A and 3B are views illustrating examples of a configuration of a fixer;

FIG. 4 is an example of a time chart according to a comparative example in which re-conveyance of continuous paper is not performed;

FIG. 5 is an example of a time chart according to an embodiment in which re-conveyance of continuous paper is performed;

FIG. 6 is an explanatory view illustrating respective positions of a lower pressure roller during separation and pressure contact of the fixer;

FIG. 7 is another example of a time chart according to the embodiment in which re-conveyance of continuous paper is performed;

FIG. 8 is a flowchart illustrating operations of the image forming apparatus; and

FIG. 9 is a flowchart illustrating operations of the image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

Below, with reference to the drawings, an image forming apparatus according to an embodiment of the present invention will be described in detail. In the drawings, the same components are denoted by the same reference signs, and duplicated description is omitted. Further, dimension ratios in the drawings are exaggerated for convenience of explanation and those are different from actual ratios in some cases.

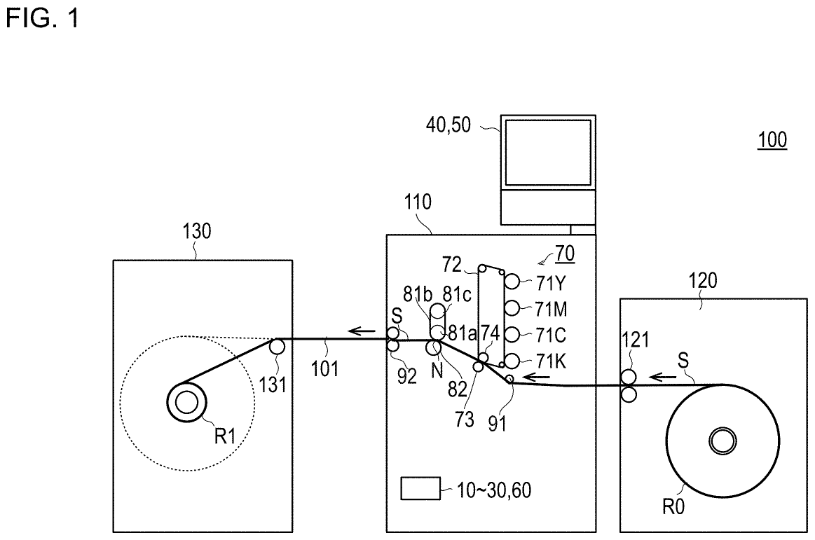

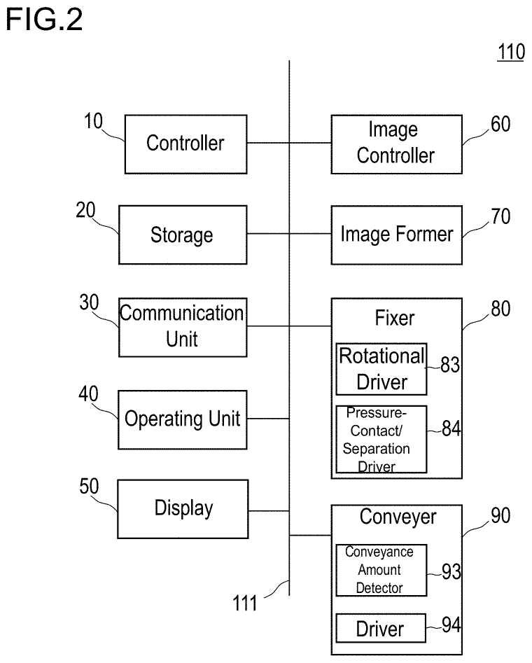

FIG. 1 is a view of an overall configuration schematically illustrating an image forming system 100. FIG. 2 is a block diagram illustrating a configuration of an image forming apparatus 110.

The image forming system 100 includes the image forming apparatus 110, a paper feeding apparatus 120, and a winding apparatus 130. The image forming apparatus 110, the paper feeding apparatus 120, and the winding apparatus 130 are connected so as to be communicatable with each other via signal lines.

The image forming system 100 can be formed by connection of the image forming apparatus 110, the paper feeding apparatus 120, and the winding apparatus 130 that are housed in different casings, respectively, via conveyance paths, for example. The image forming system 100 may be formed by connection of the image forming apparatus 110, the paper feeding apparatus 120, and the winding apparatus 130 that are housed in one casing, via conveyance paths provided in the casing.

The paper feeding apparatus 120 houses and holds a paper feeding roll R0 that is an original roll of continuous paper S, and feeds the continuous paper S to the image forming apparatus 110 on a downstream side along a conveyance direction of the continuous paper S. The image forming apparatus 110 transfers and fixes a toner image (image) onto the continuous paper S by using electrophotography to form an image on the continuous paper S, and delivers the paper to the winding apparatus 130. The continuous paper S having the image formed thereon is conveyed to the winding apparatus 130 on a downstream side along the conveyance direction of the continuous paper S, and is wound up by a collecting roll R1. The continuous paper S is conveyed along a conveyance path 101. The conveyance direction is indicated by arrows in FIG. 1.

The continuous paper S includes paper-type roll paper made of plain paper, for example, and film-type roll paper made of resin such as polypropylene or polyethylene terephthalate.

The image forming apparatus 110 will be described in more details.

The image forming apparatus 110 includes a controller 10, a storage 20, a communication unit 30, an operating unit 40, a display 50, an image controller 60, an image former 70, a fixer 80, and a conveyor 90. Those are connected with each other via buses 111.

The controller 10 can be formed of a CPU (central processing unit). The controller 10 controls respective components of the image forming apparatus 110 and performs various kinds of arithmetic processing in accordance with programs. Specifically, the controller 10 performs overall control and processing related to image formation, in cooperation with the components forming the image forming apparatus 110. Further, the controller 10 communicates with the paper feeding apparatus 120 and the winding apparatus 130 to acquire information from the paper feeding apparatus 120 and the winding apparatus 130 and control those apparatuses.

Details of operations of the controller 10 will be given later.

The storage 20 can be formed of a RAM (random access memory), a ROM (readable only memory), and an HDD (hard disk drive). The RAM, as a workspace of the controller 10, temporarily stores therein programs and data. The ROM stores therein various kinds of programs or various pieces of data in advance. The HDD stores therein an operation system and various kinds of programs including programs used by the controller 10 for controlling the components of the image forming apparatus 110, the paper feeding apparatus 120, and the winding apparatus 130. Further, in the HDD, print jobs and image data that are received via the communication unit 30, and the other various kinds of data are saved.

The print job is a generic name for a printing instruction to be given to the image forming apparatus 110, and includes print data and print setting. The print data is data of a document that is an object to be printed. The print data can include various kinds of data such as image data, vector data, and text data, for example. More specifically, the print data can be PDL (page description language) data, PDF (portable document format) data, or TIFF (tagged image file format) data. The print setting is setting related to formation of the image on the continuous paper S. The print setting can include various kinds of settings such as number of pages, number of printed copies, kind, thickness, and basis weight of the continuous paper S, and conveyance speed of the continuous paper S, for example. Additionally, the print setting can be provided with the operating unit 40 also.

The communication unit 30 is an interface for enabling communication between the image forming apparatus 110 and an external apparatus. As the communication unit 30, network interfaces compliant with standards of Ethernet (registered trademark), SATA, PCI Express, USB, IEEE1394 and the like can be used. Alternatively, as the communication unit 30, various kinds of local-area network interfaces or the like including wireless communication interfaces and the like such as Bluetooth (registered trademark) and IEEE802.11 may be used.

The operating unit 40 includes a touch panel for performing various kinds of setting, and further includes various kinds of fixed keys such as a numeric keypad for setting the number of copies and the like, a start key for giving an instruction for starting an operation, a stop key for giving an instruction for stopping an operation, a reset key for initializing various kinds of setting conditions, and the like.

The display 50 includes a touch panel for displaying various kinds of information and inputting various kinds of set values, a display lamp, and the like. Additionally, functions in which the operating unit 40 and the display 50 overlap each other can be provided to either the operating unit 40 or the display 50.

The image controller 60 performs layout and rasterization of the print data included in the print job received from the communication unit 30, and generates the image data that is data of the image in a bitmap format.

The image former 70 forms the toner image on a surface of the continuous paper S based on the image data through processes of electrification, exposure, development and transfer by using electrography.

The image former 70 includes writing units (not illustrated) corresponding to basic colors, respectively, development units 71Y, 71M, 71C, and 71K (which will be hereinafter collectively referred to as “development units 71”), an intermediate transfer belt 72, a transfer roller 73, a counter roller 74, and the like.

The respective development units 71 have the same configuration except that colors of toner stored therein are different from each other. Exposure in the writing units corresponding to the image data forms latent images on photoconductor drums of the development units 71. The latent images are developed by a developer, thereby forming the toner images in respective colors. The toner images are transferred onto the intermediate transfer belt 72 serving as an image carrier (primary transfer) and are sequentially superposed, so that a full-color toner image is formed.

The intermediate transfer belt 72 is stretched over a plurality of rollers such as the counter roller 74. The transfer roller 73 is impelled under a predetermined pressure toward the counter roller 74 with the intermediate transfer belt 72 interposed therebetween. This forms a nip between the intermediate transfer belt 72 covering the counter roller 74 and the transfer roller 73. The toner image formed on the intermediate transfer belt 72 is transferred onto the continuous paper S (secondary transfer) in the nip, so that the toner image is formed on the continuous paper S. The toner image is heated and pressurized in the fixer 80, to be fixed onto a surface of the continuous paper S.

Though the image forming apparatus adopting an intermediate-transfer-belt system is described in the present embodiment as an example, there may be provided the image forming apparatus adopting a direct transfer system in which the intermediate transfer belt 72 is not included and the image is transferred from the photoconductor drum directly to the continuous paper S. In this image forming apparatus adopting a direct transfer system, photoconductor drums serving as a plurality of image carriers and their corresponding plural transfer rollers are arranged side by side along a conveyance direction, and the toner images in respective colors formed on the photoconductor drums are sequentially superposed and transferred onto the continuous paper S, thereby forming a full-color toner image.

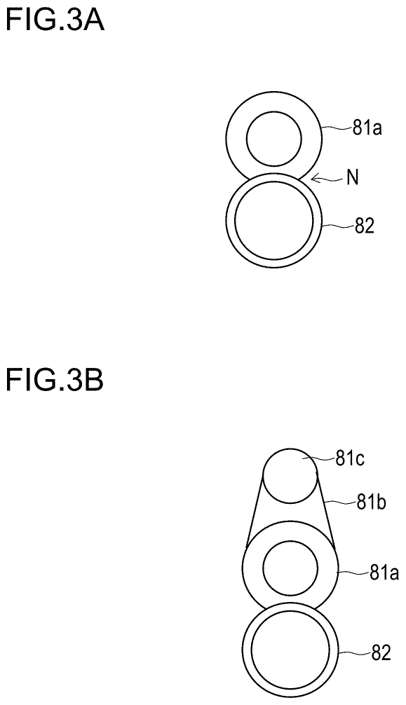

FIGS. 3A and 3B are views illustrating examples of a configuration of the fixer 80.

FIG. 3A illustrates a configuration of the fixer 80 including an upper pressure roller 81a and a lower pressure roller 82. In this example, the upper pressure roller 81a and the lower pressure roller 82 come into pressure contact with each other, thereby forming a fixing nip N. The upper pressure roller 81a is a cored bar that is made of metal such as iron and is covered with an elastic layer, for example. As the elastic layer, heat-resistant silicon rubber can be used, for example. The elastic layer may have a configuration in which heat-resistant silicon rubber is covered with PTFE (polytetrafluoroethylene) that is heat-resistant resin. The lower pressure roller 82 is an outer surface of a PI (polyimide) material covered with an elastic layer, for example. As the elastic layer, heat-resistant silicon rubber can be used, for example. The elastic layer may have a configuration in which heat-resistant silicon rubber is covered with a PFA (perfluoroalkoxy) tube serving as a surface release layer. In the example of FIG. 3A, the upper pressure roller 81a and the lower pressure roller 82 form rotors.

FIG. 3B illustrates a configuration of the fixer 80 including the upper pressure roller 81a, a fixing belt 81b, a heating roller 81c, and the lower pressure roller 82. In this example, the upper pressure roller 81a and the lower pressure roller 82 come into pressure contact with each other with the fixing belt 81b interposed therebetween, thereby forming the fixing nip N between the fixing belt 81b and the lower pressure roller 82. The fixing belt 81b can have a configuration in which an outer surface of a PI material is covered with heat-resistant silicon rubber serving as an elastic layer and is further covered with a PFA tube that is heat-resistant resin. In the example of FIG. 3B, the fixing belt 81b and the lower pressure roller 82 form rotors.

Below, for easier explanation, description will be made on the assumption that the fixer 80 has the configuration in FIG. 3B.

The fixer 80 fixes the toner image formed on a surface of the continuous paper S by heating and pressurizing the toner image in the fixing nip N. In a hollow space inside the heating roller 81c, a plurality of heaters such as halogen lamps are arranged.

The endless fixing belt 81b is stretched over the heating roller 81c and the upper pressure roller 81a. The fixing belt 81b comes into contact with the heating roller 81c heated by the heaters, so that the temperature of the fixing belt 81b is controlled (heated) at a predetermined temperature by the heating roller 81c.

The lower pressure roller 82 is impelled under a predetermined pressure toward the upper pressure roller 81a with the fixing belt 81b interposed therebetween. This brings the fixing belt 81b covering the upper pressure roller 81a and the lower pressure roller 82 into pressure contact with each other, thereby forming the fixing nip N between the fixing belt 81b and the lower pressure roller 82. The toner image formed on the continuous paper S is conveyed to the fixing nip N by the conveyor 90. While the toner image is passing through the fixing nip N by rotation of the fixing belt 81b and the lower pressure roller 82, the toner image is heated and pressurized, to be fixed onto a surface of the continuous paper S.

At least one of the upper pressure roller 81a and the lower pressure roller 82 is driven and rotated by a rotational driver 83 including a rotor driving motor. Specifically, the upper pressure roller 81a and the lower pressure roller 82 can rotate when torque is given from the rotor driving motor, and can stop rotating when no torque is given. Rotation of the upper pressure roller 81a causes rotation of the fixing belt 81b. By rotation of the fixing belt 81b and the lower pressure roller 82, the continuous paper S is heated and pressurized in the fixing nip N and is conveyed. As the rotor driving motor, a DC brushless motor can be used.

The conveyor 90 includes a conveyance roller 91, a paper discharge roller 92, and a driver 94 including motors that drive the conveyance roller 91 and the paper discharge roller 92, respectively. As the motors, stepping motors can be used.

The conveyor 90 includes a conveyance amount detector 93. The conveyance amount detector 93 forms a detector, and detects a conveyance amount of the continuous paper S on an upstream side of the fixer 80 along the conveyance direction. The conveyance amount detector 93 includes an encoder that is provided in the conveyance roller 91 disposed on an upstream side of the fixer 80 along the conveyance direction. The encoder measures the number of rotations of the conveyance roller 91, based on which the conveyance amount of the continuous paper S can be detected.

Two rollers of the paper discharge roller 92 are impelled to each other to form a nip, and convey the continuous paper S being grasped. The conveyance roller 91 is a driven roller, and rotates while coming into contact with a surface (upper surface) of the continuous paper S.

The conveyance path 101 can be formed as a path along which the continuous paper S is conveyed by rotation of the conveyance roller 91 and the paper discharge roller 92. The conveyance path 101 can further include a path along which the continuous paper S is conveyed by rotation of a roller 121 of the paper feeding apparatus 120 and a roller 131 of the winding apparatus 130.

Operations of the controller 10 will be described.

The controller 10 controls the image former 70 and the fixer 80 in accordance with the print job, thereby forming the image on the continuous paper S.

The controller 10 causes at least one of the upper pressure roller 81a and the lower pressure roller 82 to be driven for rotation by the rotor driving motor. Thus, the controller 10 controls rotation, stop of rotation, and rotation speeds of the fixing belt 81b and the lower pressure roller 82.

The controller 10 causes the paper discharge roller 92 to be driven by the motor of the driver 94. Thus, the controller 10 controls rotation, stop of rotation, and a rotation speed of the paper discharge roller 92.

The controller 10 causes a position of the lower pressure roller 82 to be switched between a position where the lower pressure roller 82 comes into pressure contact with the upper pressure roller 81a and a position where the lower pressure roller 82 separates from the upper pressure roller 81a, by a pressure-contact/separation driver 84 that changes a position of the lower pressure roller 82. Thus, the controller 10 switches the fixing belt 81b and the lower pressure roller 82 between pressure contact and separation. In other words, the controller 10 controls formation and release of the fixing nip N. Hereinafter, pressure contact between the fixing belt 81b and the lower pressure roller 82 will be referred to as “pressure contact of the fixer 80”, and separation of the fixing belt 81b and the lower pressure roller 82 from each other will be referred to as “separation of the fixer 80”.

The controller 10 controls operations of the heaters for heating the heating roller 81c, thereby heating the fixing belt 81b or stopping heating the fixing belt 81b.

After execution of the print job, the controller 10 warms up the fixer 80 for a fixing operation of the fixer 80 in executing a next print job. Warm-up of the fixer 80 is an operation of heating and/or maintaining the fixing belt 81b at a predetermined fixing temperature. As will be described later, the fixer 80 is warmed up through release of the fixing nip N, heating of the heating roller 81c, and rotation of the fixing belt 81b.

The controller 10 detects that the image lastly formed in accordance with the print job (which will be hereinafter referred to as “the last image”) has passed through the fixer 80. The controller 10 detects that the last image has passed through the fixer 80 in the following manner, for example. A period of time from a time when the toner image is formed (transferred) on the continuous paper S to a time when the toner image is fixed onto the continuous paper S in the fixer 80 and passes through the fixer 80 is previously stored in the storage 20. The controller 10 measures a period of time from the time when the toner image is formed on the continuous paper S, by using a timer (not illustrated) provided in the image forming apparatus 110, and can detect that the last image has passed through the fixer 80 based on elapse of the period of time stored in the storage 20. Additionally, the controller 10 may detect that the last image has passed through the fixer 80 by using an optical sensor that is arranged along the conveyance direction of the conveyance path 101 and detects the image on the continuous paper S.

After the controller 10 detects that the last image has passed through the fixing nip N, the controller 10 releases the fixing nip N, stops rotation of the fixing belt 81b and the lower pressure roller 82, and stops conveyance of the continuous paper S by the paper discharge roller 92 and the like, thereby stopping conveyance of the continuous paper S. The controller 10, which has stopped conveyance of the continuous paper S, performs re-conveyance in which the continuous paper S is conveyed by the paper discharge roller 92 with the fixing nip N being released and without rotation of the fixing belt 81b, before warming up the fixer 80. This re-conveyance removes slack in the continuous paper S. After the re-conveyance of the continuous paper S, the controller 10 warms up the fixer 80 for the fixing operation of the fixer 80 in accordance with the next print job. The controller 10 stops the re-conveyance of the continuous paper S while leaving the fixing nip N released, and warms up the fixer 80 by rotating the fixing belt 81b and heating the fixing belt 81b.

Reasons for re-conveyance of the continuous paper S will be described.

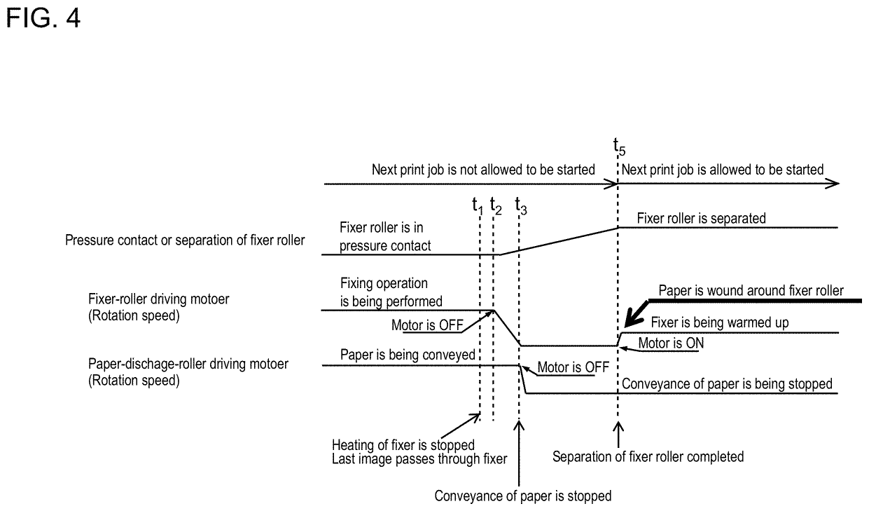

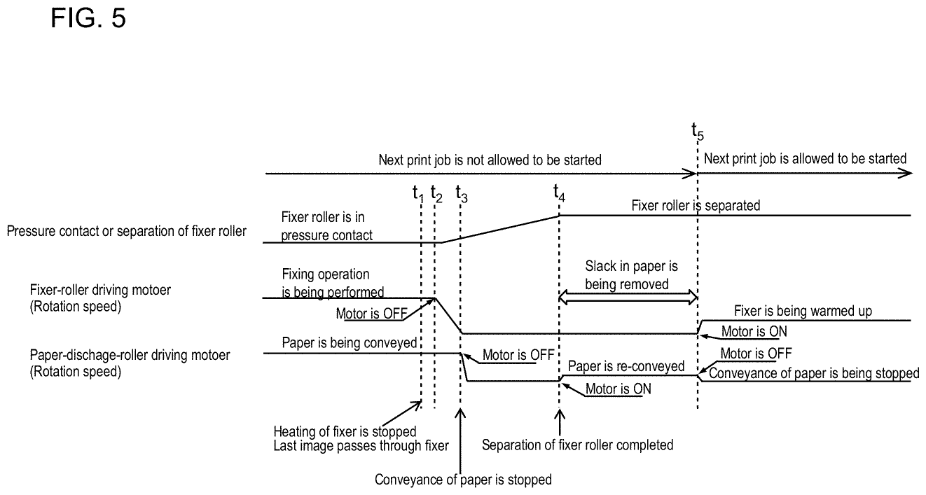

FIG. 4 is an example of a time chart according to a comparative example in which re-conveyance of the continuous paper S is not performed. FIG. 5 is an example of a time chart according to the embodiment in which re-conveyance of the continuous paper S is performed.

Referring to FIG. 4, until a time t1, the fixer 80 is in pressure contact, and the motor (fixer-roller driving motor) for driving for rotating the fixing belt 81b (for driving for rotating the upper pressure roller 81a, more strictly), and the motor (paper-discharge-roller driving motor) for driving the paper discharge roller 92 are driven. Thus, the fixer 80 performs the fixing operation. At the time t1 when the last image passes through the fixer 80, heating of the fixing belt 81b (the heating roller 81c) of the fixer 80 is stopped. Subsequently, the fixer-roller driving motor and the paper-discharge-roller driving motor are stopped (turned OFF) at a time t2 and a time t3, respectively, so that conveyance of the continuous paper S is stopped at the time t3. Then, at a time t5 when separation of the fixer 80 is completed (in other words, the fixing nip N is released), warm-up of the fixer 80 is started. Additionally, after the time t5, the next print job is allowed to be executed.

For the warm-up of the fixer 80, while the fixer 80 is left separated and conveyance of the continuous paper S is stopped by stop of the paper-discharge-roller driving motor, the fixer-roller driving motor is caused to operate (to be ON) to rotate the fixing belt 81b and heat the heating roller 81c. According to the conventional art, the continuous paper S is conveyed during warm-up of the fixer 80. In contrast thereto, by warming up the fixer 80 while stopping conveyance of the continuous paper S in such a manner as in the comparative example of FIG. 4, it is possible to reduce waste paper generated due to conveyance of the continuous paper S during warm-up of the fixer 80.

However, when the fixer-roller driving motor and the paper-discharge-roller driving motor are stopped (turned OFF) at the time t2 and the time t3, respectively, slack occurs in the continuous paper S due to inertia in stopping rotation of the fixing belt 81b and the like. Further, as will be described later, slack occurs in the continuous paper S also due to release of the fixing nip N at the time t5. Then, warming up the fixer 80 with slack in the continuous paper S causes the slack in the continuous paper S to be drawn in, and be wound around, the fixing belt 81b because of rotation of the fixing belt 81b required for warming up the fixer 80. This is called winding of the continuous paper S around the fixing belt 81b (or is simply referred to as “winding”). Further, because of stop of conveyance of the continuous paper S during warm-up of the fixer 80, heat of the fixer 80 is transmitted to the continuous paper S via air even though the fixer 80 and the continuous paper S are not in contact with each other, which deforms the continuous paper S and further promotes winding in some cases.

It is possible to prevent winding by sensing whether tension is uniformly applied to the continuous paper S and suspending warm-up of the fixer 80 if tension is not uniformly applied to the continuous paper S. Nonetheless, though tension is uniformly applied across the paper feeding roll R0 of the paper feeding apparatus 120 and the collecting roll R1 of the winding apparatus 130, slack can instantaneously occur in the continuous paper S inside the image forming apparatus 110. In such a case, it is determined that tension is not uniformly applied to the continuous paper S, and thus the fixer 80 cannot be warmed up speedily after output of the last image. By driving for rotating the paper feeding roll R0 and the collecting roll R1 in a reverse direction and a forward direction, respectively, to uniformly apply tension to the continuous paper S, it is possible to remove slack occurring inside the image forming apparatus 110. However, removing slack in such a way takes a relatively long period of time.

With reference to FIG. 5, the example of a time chart according to the embodiment will be described. Until the time t1, the controller 10 keeps the fixer 80 in pressure contact and drives the rotor driving motor (fixer-roller driving motor) for driving for rotating the fixing belt 81b (for driving for rotating the upper pressure roller 81a, more strictly) and the motor (paper-discharge-roller driving motor) for driving the paper discharge roller 92. Thus, the controller 10 causes the fixer 80 to perform the fixing operation. At the time t1 when the last image passes through the fixer 80, the controller 10 stops heating of the fixing belt 81b (heating roller 81c) of the fixer 80. Subsequently, the controller 10 stops (turns OFF) the fixer-roller driving motor and the paper-discharge-roller driving motor at the time t2 and the time t3, respectively, to stop conveyance of the continuous paper S at the time t3. Then, the controller 10 completes separation of the fixer 80 (releases the fixing nip N) at a time t4.

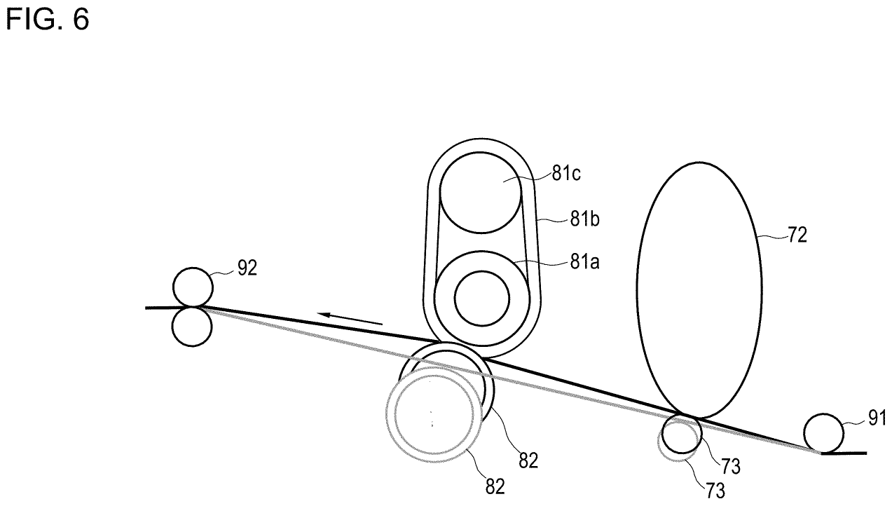

FIG. 6 is an explanatory view illustrating respective positions of the lower pressure roller 82 during separation and pressure contact of the fixer 80.

In FIG. 6, the lower pressure roller 82 and the continuous paper S during separation of the fixer 80 are indicated by gray lines. On the other hand, the lower pressure roller 82 and the continuous paper S during pressure contact of the fixer 80 are indicated by black lines. It is noted that during separation of the fixer 80, also the intermediate transfer belt 72 and the transfer roller 73 can be separated from each other. In FIG. 6, a position of the transfer roller 73 during separation of the fixer 80 and a position of the transfer roller 73 during pressure contact of the fixer 80 are indicated by a gray line and a black line, respectively.

As illustrated in FIG. 6, a conveyance path of the continuous paper S during pressure contact of the fixer 80 is longer than that during separation of the fixer 80. This is because a pressure to be applied to the continuous paper S in the fixing nip N needs to be equal to or higher than a predetermined pressure. Thus, during separation of the fixer 80, slack occurs in the continuous paper S due to a difference of a conveyance-path length from a conveyance-path length during pressure contact of the fixer 80.

In the above-described manners, slack occurs in the continuous paper S due to inertia in stopping rotation of the fixing belt 81b and the like and due to separation of the fixer 80.

Referring back to FIG. 5, further description will be given.

The controller 10 re-conveys the continuous paper S after completing separation of the fixer 80 at the time t4. For the re-conveyance of the continuous paper S, with the fixer 80 being left separated (the fixing nip N being released) and without rotation of the fixing belt 81b by the fixer-roller driving motor, the paper-discharge-roller driving motor is caused to operate (to be ON). In this manner, the continuous paper S is re-conveyed. That is, re-conveyance of the continuous paper S is conveyance by the paper discharge roller 92. Re-conveyance of the continuous paper S generates certain tension in the continuous paper S, thereby removing slack in the continuous paper S. The conveyance speed of the continuous paper S in re-conveyance is made lower than the conveyance speed in fixing the image on the continuous paper S in the fixer 80. This reduces an amount of waste paper generated due to re-conveyance of the continuous paper S. Further, slack in the continuous paper S due to inertia in stopping re-conveyance is reduced.

The controller 10, even if it is placed under the conditions that allow warm-up to be performed before the time t5 by input of the next print job or the like before the time t5, does not start warm-up until the time t5, but starts warming up the fixer 80 at the time t5 when the conveyance amount of the continuous paper S in re-conveyance of the continuous paper S reaches a predetermined conveyance amount. The predetermined conveyance amount can be previously set using the minimum conveyance amount that can remove slack in the continuous paper S. The minimum conveyance amount can be experimentally determined. A conveyance amount of the continuous paper S can be detected by the conveyance amount detector 93, for example. For warm-up of the fixer, 80, the controller 10 causes the fixer-roller driving motor to operate (to be ON) to rotate the fixing belt 81b and heat the heating roller 81c while the fixer 80 is left separated and conveyance of the continuous paper S is stopped by stop of rotation of the paper discharge roller 92. During warm-up of the fixer 80, stop of conveyance of the continuous paper S can prevent waste paper from being generated due to warm-up of the fixer 80.

The controller 10 is allowed to execute the next print job after the time t5 when re-conveyance of the continuous paper S is ended.

The controller 10 does not start warming up the fixer 80 until the time t5 when re-conveyance of the continuous paper S is ended. This prevents the re-conveyance of the continuous paper S from being interrupted by start of warm-up of the fixer 80.

The controller 10 does not cause the image former 70 to form the toner image on the continuous paper S until re-conveyance of the continuous paper S is ended. This prevents re-conveyance of the continuous paper S from being interrupted by formation of the toner image on the continuous paper S in the image former 70.

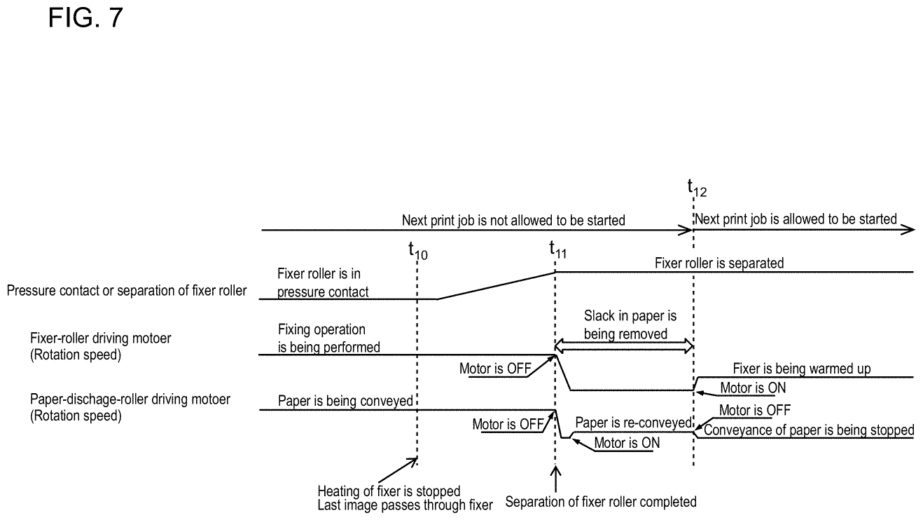

The controller 10 can control termination of the fixing operation of the fixer 80 by the following methods. The controller 10 stops rotation of the fixing belt 81b and the lower pressure roller 82 and conveyance of the continuous paper S by the paper discharge roller 92 after passage of the last image through the fixing nip N, and subsequently releases the fixing nip N (first method). This method is the control of termination of the fixing operation, exerted from the time t2 and the time t4 in the example of FIG. 5. Alternatively, as will be described later (refer to FIG. 7), the controller 10 may control termination of the fixing operation by the following method. The controller 10 releases the fixing nip N after passage of the last image through the fixing nip N, and subsequently stops rotation of the fixing belt 81b and the lower pressure roller 82, and conveyance of the continuous paper S by the paper discharge roller 92 (second method).

The controller 10 causes the conveyance amount detector 93 to detect a conveyance amount of the continuous paper S on the upstream side of the fixer 80 along the conveyance direction of the continuous paper S. The conveyance amount of the continuous paper S on the upstream side of the fixer 80 along the conveyance direction of the continuous paper S is detected by the conveyance amount detector 93. In a case where a first conveyance amount of the continuous paper S in a first period from a time when the controller 10 stops rotation of the fixing belt 81b and the lower pressure roller 82 and conveyance of the continuous paper S by the paper discharge roller 92 after passage of the last image through the fixing nip N to a time when the fixing nip N is released, is equal to or smaller than a predetermined first threshold value, the controller 10 does not re-convey the continuous paper S. Alternatively, in a case where a second conveyance amount of the continuous paper S in a second period from a time, after passage of the last image through the fixing nip N, when rotation of the fixing belt 81b and the lower pressure roller 82 is stopped after the fixing nip N is released to a time when a predetermined period of time elapses, is equal to or smaller than a predetermined second threshold value, the controller 10 does not re-convey the continuous paper S. For the predetermined period of time, a period of time from a time when rotation of the fixing belt 81b and the lower pressure roller 82 is stopped after release of the fixing nip N to a time when conveyance of the continuous paper S is not detected by the conveyance amount detector 93 is measured through experiments. Then, the predetermined period of time can be set based on the results of the measurement. The reasons for not re-conveying the continuous paper S in the above-described cases are as follows. The above-described first conveyance amount and second conveyance amount have values reflecting an amount of slack in the continuous paper S. Thus, in a case where the first conveyance amount and the second conveyance amount are relatively small, an amount of slack in the continuous paper S is small. Hence, it is considered that there is no need to re-convey the continuous paper S. For the first threshold value and the second threshold value, respective relations of the first conveyance amount and the second conveyance amount to occurrence of winding of the continuous paper S are experimentally obtained, for example. Then, the respective maximum values of the first and second conveyance amounts that do not involve winding of the continuous paper S, can be used.

The controller 10 determines whether to re-convey the continuous paper S based on printing conditions set as the print setting in the print job. The printing conditions being referred to in determining whether to re-convey includes the conveyance speed of the continuous paper S, for example. The printing conditions may include at least one of the kind, the thickness, and the basis weight of the continuous paper S. The conveyance speed of the continuous paper S can be set based on at least one of the kind, the thickness, and the basis weight of the continuous paper S. For example, a table that defines relations between the kinds or the like of the continuous paper S and the conveyance speeds of the continuous paper S is previously stored in the storage 20, and thus the conveyance speed of the continuous paper S can be set based on the kind or the like of the continuous paper S by using the table. The conveyance speed of the continuous paper S may be set by a user's input with the operating unit 40. In a case where the conveyance speed of the continuous paper S is high, inertia in stopping rotation of the fixing belt 81b is increased and slack of the continuous paper S becomes great, which allows winding of the continuous paper S around the fixing belt 81b to easily occur. Hence, the controller 10 determines to re-convey the continuous paper S when the conveyance speed of the continuous paper S is equal to or higher than a predetermined threshold value, and determines not to re-convey the continuous paper S when the conveyance speed of the continuous paper S is lower than the predetermined threshold value. For the predetermined threshold value, relations of conveyance speeds of the continuous paper S to occurrence of winding of the continuous paper S are experimentally obtained, for example. Then, the lowest conveyance speed at which winding of the continuous paper S occurs can be used. Further, in a case where the continuous paper S is plain paper in its kind and its thickness is relatively small, for example, the controller 10 can determine not to re-convey the continuous paper S. It is possible to appropriately set the printing conditions being referred to in determining whether to re-convey the continuous paper S, as well as set the threshold value for each printing condition, by experimentally obtaining relations of the printing conditions to occurrence of winding of the continuous paper S.

The controller 10 changes a conveyance amount of the continuous paper S in re-conveyance in accordance with printing conditions set as the print setting in the print job. For example, in a case where the continuous paper S is plain paper, an amount of slack is relatively small, and thus the conveyance amount in re-conveyance is made relatively small. The printing conditions being referred to in changing the conveyance amount of the continuous paper S in re-conveyance can be determined by extraction of printing conditions highly correlated with winding through experiments or the like, for example. For the conveyance amount of the continuous paper S in re-conveyance, for example, relations of conveyance amounts in re-conveyance to occurrence of winding of the continuous paper S are experimentally obtained. Then, the minimum conveyance amount that does not allow occurrence of winding can be used. A case where the conveyance amount in re-conveyance is changed is a case where the kind of the continuous paper S on which the image is to be formed by the print job is different from the kind of the continuous paper S on which the image has been formed by another print job having been executed immediately before the foregoing print job. Even in a case where the kind of the continuous paper S on which the image is to be formed by the print job is the same as the kind of the continuous paper S on which an image has been formed by another print job having been executed immediately before the foregoing print job, if the respective conveyance speeds are different, the conveyance amount in re-conveyance can be changed.

FIG. 7 illustrates another example of a time chart according to the embodiment in which re-conveyance of the continuous paper S is performed. The example of FIG. 5, as compared to the present example, is different in a method of controlling termination of the fixing operation. More specifically, in the example of FIG. 5, conveyance of the continuous paper S is stopped by the first method in which rotation of the fixing belt 81b and the like and conveyance of the continuous paper S by the conveyor 90 are stopped after passage of the last image through the fixing nip N and then the fixing nip N is released. On the other hand, in the present example, conveyance of the continuous paper S is stopped by the second method in which after passage of the last image through the fixing nip N, the fixing nip N is released after rotation of the fixing belt 81b and the like and conveyance of the continuous paper S by the conveyor 90 are stopped.

Until a time t10, the controller 10 keeps the fixer 80 in pressure contact and drives the fixer-roller driving motor for driving for rotating the fixing belt 81b (for driving for rotating the upper pressure roller 81a, more strictly) and the paper-discharge-roller driving motor for driving the paper discharge roller 92. Thus, the controller 10 causes the fixer 80 to perform the fixing operation. At the time t10 when the last image passes through the fixer 80, the controller 10 stops heating of the fixing belt 81b (heating roller 81c) by the heating roller 81c of the fixer 80. Subsequently, the controller 10 completes separation of the fixer 80 (releases the fixing nip N) at a time t1 The controller 10, which has completed separation of the fixer 80, stops (turns OFF) the fixer-roller driving motor and the paper-discharge-roller driving motor, thereby stopping conveyance of the continuous paper S.

The controller 10 stops the fixer-roller driving motor and the paper-discharge-roller driving motor to stop conveyance of the continuous paper S, and subsequently re-conveys the continuous paper S. The controller 10 re-conveys the continuous paper S by causing the paper-discharge-roller driving motor to operate (to be ON) with the fixer 80 being left separated and without rotation of the fixing belt 81b by the fixer-roller driving motor. Re-conveyance of the continuous paper S is conveyance by the paper discharge roller 92. Re-conveyance of the continuous paper S generates certain tension in the continuous paper S, which removes slack in the continuous paper S. The conveyance speed of the continuous paper S in re-conveyance is made lower than the conveyance speed in fixing the image on the continuous paper S in the fixer 80. This reduces an amount of waste paper generated due to re-conveyance of the continuous paper S.

The controller 10 starts warming up the fixer 80 at a time t12 when the conveyance amount of the continuous paper S in re-conveyance of the continuous paper S reaches a predetermined conveyance amount. The predetermined conveyance amount can be previously set using the minimum conveyance amount that can remove slack in the continuous paper S. The minimum conveyance amount can be experimentally determined. To warm up the fixer 80, the controller 10 causes the fixer-roller driving motor to operate (to be ON) to rotate the fixing belt 81b and heat the heating roller 81c with the fixer 80 being left separated and rotation of the paper discharge roller 92 being stopped by stopping the paper-discharge-roller driving motor.

The controller 10 is allowed to execute the next print job after the time t12 when re-conveyance of the continuous paper S is ended.

Operations of the image forming apparatus will be described.

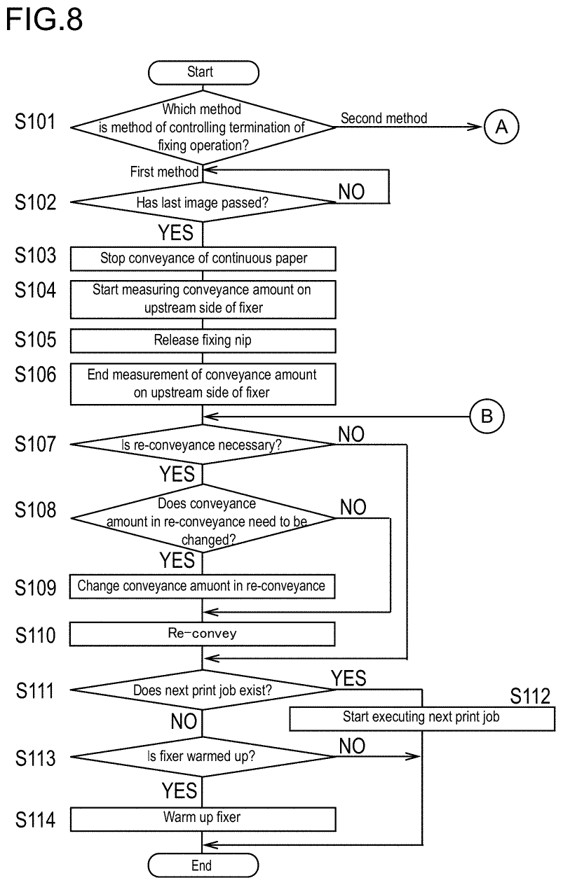

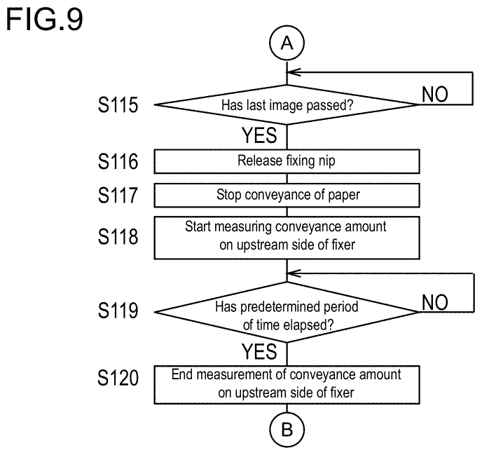

FIGS. 8 and 9 are flowcharts illustrating the operations of the image forming apparatus 110. Steps in the flowcharts are performed by the controller 10 of the image forming apparatus 110 in accordance with programs.

The controller 10 determines the method of controlling termination of the fixing operation (S101). The method of controlling termination of the fixing operation is the above-described first method (in which the fixing nip N is released after stop of conveyance), or the above-described second method (in which conveyance is stopped after release of the fixing nip N). Which method of the first method and the second method is adopted as the method of controlling termination of the fixing operation can be set in the print setting.

If the controller 10 determines that the method of controlling termination of the fixing operation is the first method (S101: First method), the controller 10 performs steps S102 to S114.

The controller 10 determines whether the last image has passed through the fixer 80 (S102). If the controller 10 determines that the last image has not passed through the fixer 80 (S102: NO), the controller 10 performs the step S102 again.

If the controller 10 determines that the last image has passed through the fixer 80 (S102: YES), the controller 10 stops driving for rotation of the fixing belt 81b, the lower pressure roller 82, and the paper discharge roller 92 to stop conveyance of the continuous paper S (S103), and starts measuring the conveyance amount of the continuous paper S on the upstream side of the fixer 80 (S104).

Subsequently, the controller 10 releases the fixing nip N (S105), and ends measurement of the conveyance amount of the continuous paper S on the upstream side of the fixer 80 (S106). Thereby, the conveyance amount from a time when driving and rotation of the fixing belt 81b, the lower pressure roller 82, and the paper discharge roller 92 are stopped to stop conveyance of the continuous paper S to a time when the fixing nip N is released (first conveyance amount) is detected.

The controller 10 determines whether re-conveyance of the continuous paper S is necessary based on printing conditions set in the print setting (S107). Further, the controller 10 determines whether re-conveyance of the continuous paper S is necessary based on the above-described first conveyance amount being an amount of conveyance from a time when driving for rotation of the fixing belt 81b, the lower pressure roller 82, and the paper discharge roller 92 are stopped to stop conveyance of the continuous paper S to a time when the fixing nip N is released.

If the controller 10 determines that re-conveyance of the continuous paper S is unnecessary (S107: NO), the controller 10 performs a process at a step S111.

If the controller 10 determines that re-conveyance of the continuous paper S is necessary (S107: YES), the controller 10 determines whether the conveyance amount in the re-conveyance needs to be changed (S108). If the controller 10 determines that the conveyance amount in the re-conveyance needs not to be changed (S108: NO), the controller 10 performs a process at a step S110.

If the controller 10 determines that the conveyance amount in the re-conveyance needs to be changed (S108: YES), the controller 10 changes the conveyance amount in the re-conveyance (S109).

Subsequently, the controller 10 re-conveys the continuous paper S (S110).

Then, the controller 10 determines whether the next print job exists (S111). If the controller 10 determines that a next print job exists (S111: YES), the controller 10 starts executing that print job (S112).

If the controller 10 determines that no next print job exists (S111: NO), the controller 10 determines whether to warm up the fixer 80 (S113). If the controller 10 determines not to warm up the fixer 80 (S113: NO), the controller 10 ends the processes. The controller 10 determines not to warm up the fixer 80 when the temperature of the fixing belt 81b of the fixer 80 is equal to or higher than a predetermined temperature (fixing temperature), for example. The temperature of the fixing belt 81b can be detected by a thermocouple being brought into contact with the fixing belt 81b, for example. The temperature of the fixing belt 81b may be detected by a known non-contact thermometer.

If the controller 10 determines to warm up the fixer 80 (S113: YES), the controller 10 warms up the fixer 80 (S114).

In the step S101, if the controller 10 determines that the method of controlling termination of the fixing operation is the second method (S101: Second method), the controller 10 performs steps S115 to S120.

The controller 10 determines whether the last image has passed through the fixer 80 (S115). If the controller 10 determines that the last image has not passed through the fixer 80 (S115: NO), the controller 10 performs the step S115 again.

If the controller 10 determines that the last image has passed through the fixer 80 (S115: YES), the controller 10 releases the fixing nip N (S116) and subsequently stops driving for rotation of the paper discharge roller 92 to stop conveyance of the continuous paper S (S117).

When the controller 10 stops conveyance of the continuous paper S, the controller 10 starts measuring the conveyance amount of the continuous paper S on the upstream side of the fixer 80 (S118).

The controller 10 waits until the predetermined period of time elapses (S119: NO). When the controller 10 determines that the predetermined period of time has elapsed (S119: YES), the controller 10 ends measurement of the conveyance amount of the continuous paper S on the upstream side of the fixer 80 (S120). Thereby, the conveyance amount from a time when conveyance of the continuous paper S is stopped after release of the fixing nip N to a time when the predetermined period of time elapses (second conveyance amount) is detected.

Subsequently, the controller 10 determines whether re-conveyance of the continuous paper S is necessary based on printing conditions set in the print setting (S107). Further, the controller 10 determines whether re-conveyance of the continuous paper S is necessary based on the above-described second conveyance amount being an amount of conveyance from a time when conveyance of the continuous paper S is stopped after release of the fixing nip N to a time when the predetermined period of time elapses.

Then, the controller 10 performs processes at steps S108 to S114.

The present embodiment produces the following effects.

When the last image passes through the fixing nip, the fixing nip is released and rotation of the rotors and conveyance of the continuous paper by the conveyor are stopped. Subsequently, with the fixing nip being left released and without rotation of the rotors for warming up the fixer, the continuous paper is re-conveyed by the conveyor. Thus, the re-conveyance after stop of conveyance of the continuous paper removes slack in the continuous paper, thereby preventing winding of the continuous paper around the rotor due to the warming-up operation of the fixer.

Further, formation of the image on the continuous paper is not started until re-conveyance of the continuous paper is ended. This can avoid interruption of re-conveyance of the continuous paper due to start of the printing operation.

Further, warm-up that requires rotation of the rotors is not started until re-conveyance of the continuous paper is ended. This can avoid interruption of re-conveyance of the continuous paper due to start of the warming-up operation.

Further, after the last image passes through the fixing nip, rotation of the rotors and conveyance of the continuous paper by the conveyor are stopped and subsequently the fixing nip is released. Then, while the fixing nip is left released and rotation of the rotors is stopped, the continuous paper is re-conveyed by the conveyor. This can remove slack that occurs in the continuous paper due to the inertia of the rotors in stopping conveyance of the continuous paper and due to separation of the rotors.

Further, after the last image passes through the fixing nip, the fixing nip is released and subsequently rotation of the rotors and conveyance of the continuous paper by the conveyor are stopped. Then, while the fixing nip is left released and rotation of the rotors is stopped, the continuous paper is re-conveyed by the conveyor. This can remove slack that occurs in the continuous paper due to the other causes than the inertia of the rotors in separation of the rotors and stop of the rotors.

Further, the speed of the continuous paper in re-conveyance is made lower than the conveyance speed of the continuous paper in fixing the image on the continuous paper onto the continuous paper in the fixer. This can reduce the amount of waste paper, and can reduce slack that occurs in the continuous paper due to inertia at the end of re-conveyance.

Further, the conveyance amount of the continuous paper on the upstream side of the fixer along the conveyance direction of the continuous paper is detected. Then, if the conveyance amount detected from a time when rotation of the rotors and conveyance of the continuous paper by the conveyor are stopped to a time when release of the fixing nip N is completed is equal to or smaller than the predetermined threshold value, re-conveyance is not performed. Thus, the continuous paper is not re-conveyed in a case where there occurs such relatively small slack which does not cause winding, thereby reducing the amount of waste paper while preventing winding of the continuous paper.

Further, the conveyance amount of the continuous paper on the upstream side of the fixer along the conveyance direction of the continuous paper is detected. Then, if the conveyance amount detected from a time when rotation of the rotors and conveyance of the continuous paper by the conveyor are stopped after release of the fixing nip to a time when a predetermined period of time elapses is equal to or smaller than the predetermined threshold value, re-conveyance is not performed. Thus, the continuous paper is not re-conveyed in a case where there occurs such relatively small slack which does not cause winding, thereby reducing the amount of waste paper while preventing winding of the continuous paper.

Further, whether to re-convey the continuous paper is determined based on printing conditions. Thus, the continuous paper is not re-conveyed under printing conditions where winding does not occur, thereby reducing the amount of waste paper while preventing winding of the continuous paper.

Further, the conveyance amount of the continuous paper in re-conveyance is changed in accordance with the printing conditions. This optimizes the conveyance amount of the continuous paper in re-conveyance with a view to preventing winding, thereby removing slack occurring in the continuous paper while reducing the amount of waste paper.

The image forming apparatus according to the present invention is not limited to the above-described embodiment.

For example, a part or a whole of the processes performed by the programs in the embodiment can be performed in the form of hardware such as circuits.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus comprising:
a conveyor that conveys continuous paper;
an image former that forms an image on said continuous paper being conveyed;
a fixer that pressurizes and heats said continuous paper passing through a fixing nip with said fixing nip by bringing rotors into pressure contact with each other to form said fixing nip and rotating said rotors, to fix an image on said continuous paper onto said continuous paper; and
a hardware processor that releases said fixing nip and stops rotation of said rotors and conveyance of said continuous paper by said conveyor when a lastly formed image in accordance with a print job passes through said fixing nip, said hardware processor then performing re-conveyance in which said continuous paper is conveyed by said conveyor with said fixing nip being left released and without rotation of said rotors, before performing warm-up of said fixer.

2. The image forming apparatus according to claim 1, wherein said hardware processor does not cause said image former to start forming the image on said continuous paper until said re-conveyance is ended.

3. The image forming apparatus according to claim 1, wherein said hardware processor does not start said warm-up accompanying rotation of said rotors until said re-conveyance is ended.

4. The image forming apparatus according to claim 1, wherein said hardware processor stops rotation of said rotors and conveyance of said continuous paper by said conveyor after said lastly formed image passes through said fixing nip, then releases said fixing nip, and performs said re-conveyance of said continuous paper while said fixing nip is left released and rotation of said rotors is stopped.

5. The image forming apparatus according to claim 1, wherein said hardware processor releases said fixing nip after said lastly formed image passes through said fixing nip, then stops rotation of said rotors and conveyance of said continuous paper by said conveyor, and performs said re-conveyance of said continuous paper while said fixing nip is left released and rotation of said rotors is stopped.

6. The image forming apparatus according to claim 1, wherein a speed of said continuous paper in said re-conveyance is lower than a speed of said continuous paper in conveyance for fixing the image on said continuous paper onto said continuous paper in said fixer.

7. The image forming apparatus according to claim 4, further comprising
a detector that detects a conveyance amount of said continuous paper on an upstream side of said fixer along a conveyance direction of said continuous paper, wherein
said hardware processor does not perform said re-conveyance when the conveyance amount detected from a time when rotation of said rotors and conveyance of said continuous paper by said conveyor are stopped to a time when said fixing nip is released, is equal to or smaller than a predetermined threshold value.

8. The image forming apparatus according to claim 5, further comprising
a detector that detects a conveyance amount of said continuous paper on an upstream side of said fixer along a conveyance direction of said continuous paper, wherein
said hardware processor does not perform said re-conveyance when the conveyance amount detected from a time when rotation of said rotors and conveyance of said continuous paper by said conveyor are stopped after release of said fixing nip to a time when a predetermined period of time elapses, is equal to or smaller than a predetermined threshold value.

9. The image forming apparatus according to claim 1, wherein said hardware processor determines whether to perform said re-conveyance based on printing conditions.

10. The image forming apparatus according to claim 1, wherein said hardware processor changes the conveyance amount of said continuous paper in said re-conveyance in accordance with printing conditions.
